(19) United States
(12) Patent Application Publication
(10) Pub. No.: US 2005/0126838 A1
(43) Pub. Date: Jun. 16, 2005

(54) Remote-controlled vehicle low-power indicator and method of use

(76) Inventor: Billy S. Vaughan, San Juan Capistrano, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/737,348

(22) Filed: Dec. 15, 2003

(51) Int. Cl. G06F 17/60

(52) U.S. Cl. 180/167

(57) ABSTRACT

A vehicle and indicator apparatus comprising a remote-controlled vehicle, a power supply operably connected to the remote-controlled vehicle, a low-power indicator circuit operably connected to the power supply, and at least one low-power indicator operably connected to the low-power indicator circuit and configured to be enabled when a low-power condition is present. The vehicle's power supply comprises an electrical battery, an engine, or any other power supply utilized in remote-controlled vehicles. The low-power indicator comprises a visible indicator such as a streamer device, flag device, smoke device, or LED, and/or an audible indicator mounted on the remote-controlled vehicle or on the controller itself.

### BACKGROUND OF THE INVENTION

### INCORPORATION BY REFERENCE

Applicant hereby incorporates herein by reference, any and all U.S. patents, U.S. patent applications, and other documents and printed matter cited or referred to in this application.

1. Field of the Invention

This invention relates generally to low-power indicators, and more particularly to a remote-control vehicle low-power indicator.

2. Description of Related Art

The following art defines the present state of this field:

Epstein et al., U.S. Pat. No. 5,053,753 describes a low battery level indicator for a smoke detector. When the battery in the smoke detector becomes so weak that its voltage drops below a pre-determined value, an elongated, flexible signal member such as a tape or cord is released from the smoke detector so that it hangs down into the room below to persistently remind the occupant to replace the battery with a fresh one. The elongated signal member can be used together with a conventional device, which emits audible periodic beeps or has a periodically flashing light to indicate the low battery condition. However, the long flexible signal member continues to hang down and remind the occupant that the battery must be replaced, even after the battery has gone completely dead and the horn and lamp no longer function. This invention constitutes a potential life-saving device.

Reimers, U.S. Pat. No. 5,180,023 describes a self propelled golf bag cart assembly that allows a golfer to walk during a round of golf while having the golf cart and the contents carried by the cart. The bag cart includes a plurality of cooperative subassemblies for performing specific functions. The bag cart includes a frame subassembly, a first drive wheel subassembly, a second drive wheel subassembly, a caster subassembly, a handle subassembly, and a handgrip subassembly. Each of the drive wheel subassemblies includes a shoulder, a motor, and a wheel subassembly. Power and control is provided by directly driving a motor associated with each wheel through an electrical subassembly. The electrical subassembly includes a battery and a variety of controlling components situated in a manual control box, a main power unit the handgrip, and an optional remote control unit. The bag cart is primarily characterized by direct independent drive of the wheels, compactiblity from a use mode to a storage mode, and precise user control from the handgrip, or the remote control unit. The primary expected usage of the self-propelled golf bag cart assembly is by individual golfers on walking courses.

Huey, Jr. et al., U.S. Pat. No. 5,594,422 describes a wall-mounted stand-alone smoke detector having an elongated housing. The housing has two ends. One end forms a base. The other end houses a sensor head remote from the base. A rigid member supports the sensor and connects the sensor to the base. The sensor head has a smoke sensor, a signal conditioner and a preamplifier for respectively detecting, conditioning, amplifying and providing signals from the sensor to a signal processor in the base. A positioning probe is attached to the sensor head end of the housing for positioning the sensor spaced from a ceiling of a room. The end housing the sensor may be angled for spacing the sensor from a wall on which the detector is mounted. All mounting, display control interaction and routine maintenance can be performed within easy reach, without climbing. The base has a power supply. A signal processor in the base is connected to the sensor head. Circuitry analyzes and processes signals, recognizing an alarm state and activating audible and visual alarms. Displays on the base, which are at user eye level, provide output of the signal processor. Buttons are provided on the base to test the detector and to cancel alarms. The buttons have distinct visual and tactile indicators to differentiate them from one another. A drop flag attached to the base communicates with the sensor and persistently indicates the reduced power supply status within the detector. Several such smoke detector units (DU) are combinable with a remote output unit (ROU) communicating with the detector units.

Lalor, U.S. Pat. No. 5,983,551 describes a remote controlled apparatus and method for training retrieving and other hunting dogs and replaces all functions field assistants would normally perform during training. These functions include throwing multiple birds and retrieving dummies from different locations, in various directions and at various heights and angles, a gun shot sound, visual and audible assistance for the dog and protecting stored birds and retrieving dummies from the inexperienced dog. The apparatus is low in profile, lightweight and portable so that a single trainer can transport, setup and control the training procedure without the need of assistants. Numerous safety features have been developed which limit the possibility of accidental injury.

Backfisch, U.S. Pat. No. 6,155,177 describes a model railway system with improved banking characteristics comprising a series of track sections joined end-to-end to form a continuous track assembly and a modular trestle assembly to elevate the track assembly. The trestle assembly 32 includes a biaxially inclined coupling module that allows the track to be built at a greater incline within a tighter radius than would otherwise be possible. The model railway system includes a battery-powered locomotive with a portable hand-held remote control device 84 that uses infrared signals to send commands to the locomotive. The locomotive 110 pulls modular train cars that have coupling protrusions and beam support brackets to support accessories to build different types of cars.

Loudermilk et al., U.S. Pat. No. 6,185,851 describes a picture frame and accompanying audio message circuit is provided such that one or more desired audio messages stored in the audio message circuit associated with one or more display pictures can be played upon the touching of the pictures or the frame. When audio message playback is desired, a switch, on the frame or under a protective cover for the picture, is activated by touching. Under CPU control, digital information representing the desired audio message is retrieved from a memory device, which is subsequently converted to an analog signal and transmitted to a speaker, which produces the desired audio message perceptible to a human. In other embodiments, multiple picture and multiple messages are provided such that the user can touch a particular picture, or the switch associated with that picture, and an audio message corresponding to the picture is then played through the speaker. In still other embodiments, a system is provided with a plurality of pictures mounted in the perimeter faces of a cube or other geometrical shape, each picture having associated with it a switch for activating a message or plurality of messages.

Jacobs et al., U.S. Pat. No. 6,275,170 describes a universal adaptor for use with electronic parking meters which provides these electronic parking meters with the ability to detect the presence of a parked vehicle and to adjust the position of the detector for accomplishing the vehicle detection, to gather statistics on the parking spaces and the meters, to alert the parking authority of meters that are expired in connection with vehicles still parked, and zeroing the remaining time off of any meter once the parked vehicle departs.

Carter, U.S. Pat. No. 6,283,220 describes a remote control vehicle comprising a body having a front end and a rear end and provided with first and second ground engageable propulsion means respectively disposed on opposite sides of the vehicle and in which the first and second propulsion means are driven by first and second transmission means respectively to permit the vehicle to be propelled and steered by driving the propulsion means on one side of the vehicle independently from the propulsion means on the other side of the vehicle, a boom assembly having carrying means for carrying an implement on the boom assembly, the boom assembly being mounted on the body for lifting movement between a raised position and a lowered position by a lifting means and wherein the ground engageable propulsion means and the lifting means of the boom assembly are operable by a receiver, of an electromagnetic signal, provided on the body.

Nebrigic et al., U.S. Pat. No. 6,483,275 describes a built-in battery integrated circuit in the form of a flexible circuit board of a consumer battery senses a voltaic cell electrode voltage, and when the voltage is indicative of a low state of charge, activates an indicating system, alerting a user to the impending battery failure. In addition, a tester actuator button is placed exteriorly on the battery container to manually activate the indicating system to verify that the battery has not become so low of charge as to prevent the indicating system from functioning. Advantageously, the tester actuator button may further enable the built-in battery integrated circuit, thus having all internal electronics unpowered until a user decides to use the battery. The indicating system includes an analog indicator such as a bargraph and/or a pulse indicator such as an LED or LCD.

Our prior art search with abstracts described above teaches a smoke detector and method using an elongated flexible low battery condition indicator member, a self-propelled golf bag cart, a universally acceptable smoke detector, a remote controlled apparatus and method for training retrieving dogs, a model train system with improved banking characteristics, a picture frame with associated audio messages, a universal adaptor for electronic parking meters, a remote control vehicle, and a consumer battery having a built-in indicator, but does not teach a remote-controlled vehicle with a low-power indicator configured to detect a low-power condition of the vehicle's power supply and alert the vehicle's operator of such through actuation of the low-power indicator. The present invention fulfills these needs and provides further related advantages as described in the following summary.

### SUMMARY OF THE INVENTION

The present invention teaches certain benefits in construction and use which give rise to the objectives described below.

A vehicle and indicator apparatus generally comprises a remote-controlled vehicle, a power supply operably connected to the remote-controlled vehicle, a low-power indicator circuit operably connected to the power supply, and at least one low-power indicator operably connected to the low-power indicator circuit and configured to be enabled when a low-power condition is present. The remote-controlled vehicle may be any such vehicle operated by a remote controller, such as a land vehicle, a boat, or an aircraft. The power supply of the vehicle may be an electrical battery, an engine, or any other power supply utilized in remote-controlled vehicles. The low-power indicator may comprise a visible indicator and/or audible indicator mounted on the remote-controlled vehicle or on the controller itself. The visible indicator may be a mechanical device operably mounted on the remote-controlled vehicle such as a streamer device, a flag device, or a smoke device, or may be one of a number of other indicators such as an LED.

In use, an operator operates the remote-controlled vehicle through the remote controller, resulting in a decrease of the vehicle's power supply. This drop in power is monitored by the low-power indicator circuit. When a predetermined low-power condition of the power supply is detected, the low-power indicator is actuated to indicate low power of the power supply to the operator so that the vehicle may be safely guided back before all power is lost and the vehicle crashed or unrecovered. When the power supply is an electrical battery, the low-power indicator circuit monitors the operating voltage and compares it to a predetermined voltage range, such that the low-power indicator is actuated when the operating voltage falls outside of the desired operating voltage range. When an engine or other liquid fuel device serves as the power supply, the low-power indicator circuit instead monitors the fuel level and actuates the low-power indicator when a low-level condition is detected.

A primary objective of the present invention is to provide an apparatus and method of use of such apparatus that provides advantages not taught by the prior art.

Another objective is to provide such an invention capable of detecting a low-power condition in a remote-controlled vehicle and warning an operator of the vehicle of such condition through actuation of a low-power indicator.

A further objective is to provide such an invention capable of providing a visible low-power indicator selectively visible at a selected distance from the remote-controlled vehicle.

A still further objective is to provide such an invention capable of providing an audible low-power indicator selectively audible at a selected distance from the remote-controlled vehicle.

A yet further objective is to provide such an invention capable of selectively providing both a visible and an audible low-power indicator, either simultaneously or serially.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of an exemplary embodiment of the invention;

FIG. 2 is an enlarged, partial sectional view thereof taken along line 2-2 of FIG. 1;

FIG. 3 is a schematic view thereof;

FIG. 4 is a reduced perspective view thereof showing the invention in use;

FIG. 5 is a perspective view of another exemplary embodiment of the invention;

FIG. 6 is an enlarged, partial sectional view thereof taken along line 6-6 of FIG. 5;

FIG. 7 is an enlarged, partial sectional view of an alternate embodiment thereof taken along line 7-7 of FIG. 5;

FIG. 8 is a reduced perspective view thereof showing the invention in use;

FIG. 9 is a perspective view of still another exemplary embodiment of the invention in use;

FIG. 10 is a schematic of still another exemplary embodiment of the invention; and

FIG. 11 is a schematic of yet another exemplary embodiment of the invention.

### DETAILED DESCRIPTION OF THE INVENTION

The above described drawing figures illustrate the invention in at least one of its preferred embodiments, which is further defined in detail in the following description.

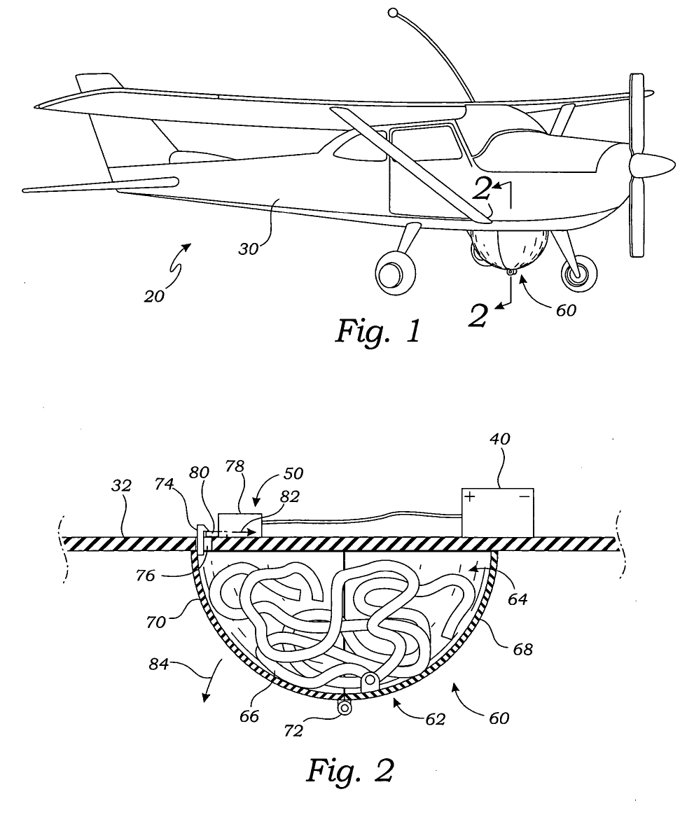

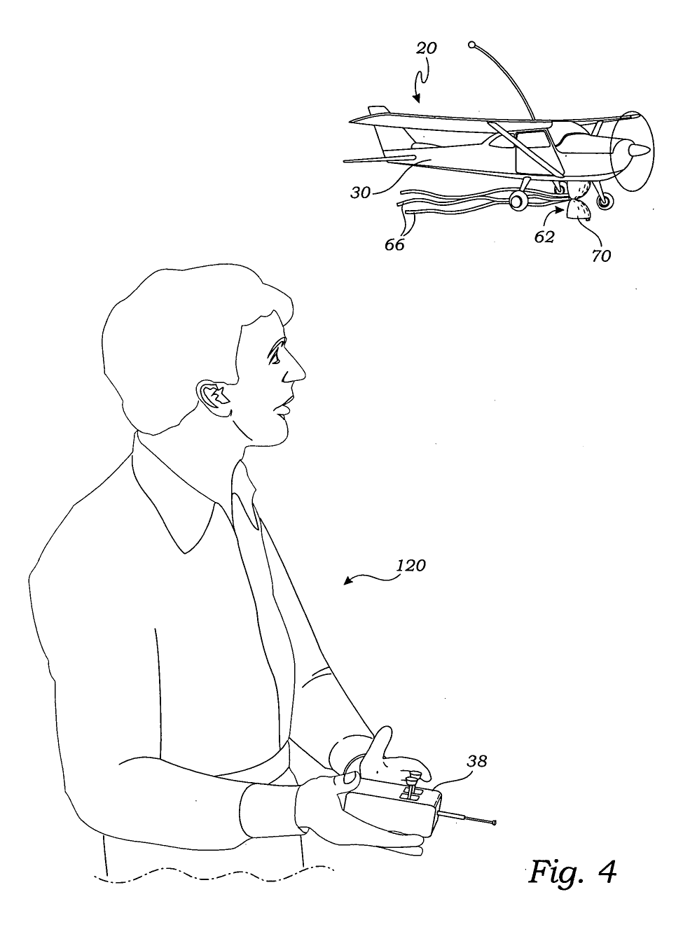

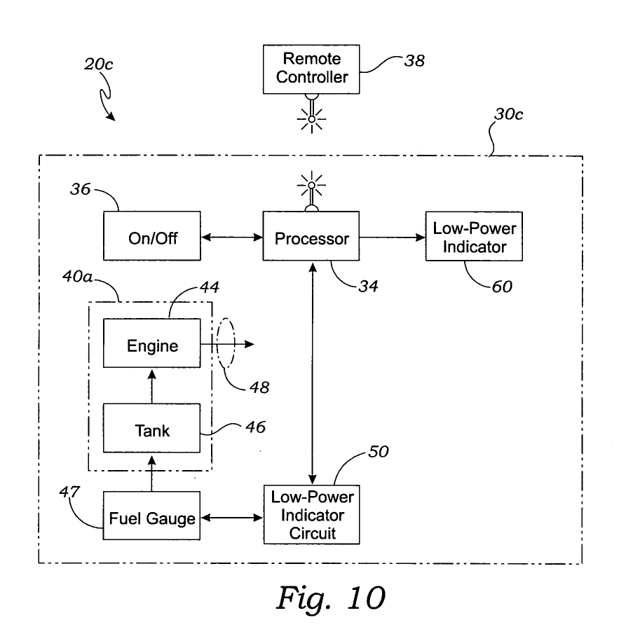

The present invention is a vehicle and indicator apparatus 20 generally comprising a remote-controlled vehicle 30, a power supply 40 operably connected to the remote-controlled vehicle 30, a low-power indicator circuit 50 operably connected to the power supply 40, and at least one low-power indicator 60 operably connected to the low-power indicator circuit 50 and configured to be enabled when a low-power condition of the vehicle 30 is present so as to alert an operator of the condition and allow the operator time to guide the vehicle 30 safely back. As will be appreciated by the discussion below, the components of the present invention may be operably connected through mechanical means or hard-wired or remote electrical means, as the case may be. The low-power indicator circuit 50 may take many forms as are known in the art, as exemplified by the low battery condition warning indicators and operating circuits shown and described in U.S. Pat. No. 5,053,752 to Epstein et al., hereby incorporated by reference in this specification. Moreover, though the incorporated reference is directed to a low battery condition circuit, it will be appreciated by those skilled in the art that similar circuitry may be employed in the low-power indicator circuit 50 of the present invention to detect low power in types of power sources other than batteries. As discussed in more detail below, in the exemplary embodiments, the low-power indicator 60 may be configured as a visible indicator, an audible indicator, or both and may be located on the remote-controlled vehicle 30 or on its controller 38. Also, in the exemplary embodiments, the remote-controlled vehicle 30 is shown and described as a remote-controlled, or radio-controlled, model aircraft, though it will be appreciated by those skilled in the art that numerous other remote-controlled vehicles, such as boats and land vehicles, may be employed without departing from the spirit and scope of the present invention. Turning now to the first exemplary embodiment of FIGS. 1-4, there is shown a remote-controlled vehicle 30 in which the at least one low-power indicator 60 comprises a visible, mechanical streamer device 62 mounted on the vehicle 30. The streamer device 62 generally comprises a selectively-openable chamber 64 formed on the remote-controlled vehicle 30 and operably connected to the low-power indicator circuit 50 and at least one streamer 66 housed within the chamber 64 and attached on one end to the chamber 64 such that opening the chamber 64 under control of the low-power indicator circuit 50 releases the streamers 66 so as to stream behind the remote-controlled vehicle 30 and visibly indicate low power. The chamber 64 is configured in two halves, with a first half 68 being rigidly mounted on the vehicle 30 and a second half 70 being pivotably mounted on the first half about a hinge 72. A clip 74 is formed on the second half 70 so as to extend through an opening 76 formed in a wall 32 of the vehicle 30. The chamber 64 is operably connected to the low-power indicator circuitry 50 through a solenoid device 78 installed on the wall 32 adjacent to the opening 76 and equipped with a slidable catch 80 so that the catch may selectively engage the clip 74 under control of the low-power indicator circuit 60 and retain the second half 70 of the chamber 64 in a closed position with the streamers 66 housed within the chamber 64, as best shown in FIG. 2. The power supply 40 is shown as an electrical battery, though it will be appreciated that numerous other power supplies, both now known, such as a gasoline engine 44 as described below in connection with the alternative exemplary embodiment of FIG. 10, and later developed, may be employed in the remote-controlled vehicle 30 and monitored for low power according to the principles of the present invention. In the case of the electrical battery power supply 40, the low-power indicator circuit 50 serves as a low-battery life indicator circuit operably connected to the battery, and the low-power indicator 60 serves as a low battery life indicator operably connected to the low-battery life indicator circuit so as to be deployed when the electrical battery has a low battery life. In the exemplary embodiment of the battery-type power supply 40, it will be appreciated by those skilled in the art that the power supply 40 provides an operating voltage within a predetermined voltage range having a nominal voltage. Two such power supplies often used in radio-controlled aircraft and the like are a nominal 4.8 volt battery having an operating voltage range of 4.720+/−0.025 volts and a nominal 6.0 volt battery having an operating voltage range of 5.860+/−0.025 volts. The low-power indicator circuit 50 is configured to detect the operating voltage and to enable actuation of the low-power indicator 60 when the operating voltage falls outside the voltage range. The power supply 40 is electrically connected across terminals 42 to the other components of the vehicle 30 such as a central processor 34 and an on/off switch 36 and the low-power indicator 60 itself as required. The processor 34 may operate in conjunction with the low-power indicator circuit 50 to selectively control the low-power indicator 60, as schematically shown in FIG. 4, though it will be appreciated that the low-power indicator circuit 50 may directly control the low-power indicator 60 without the cooperation of the processor 34. The processor 34 also communicates with the remote controller 38 as is known in the art.

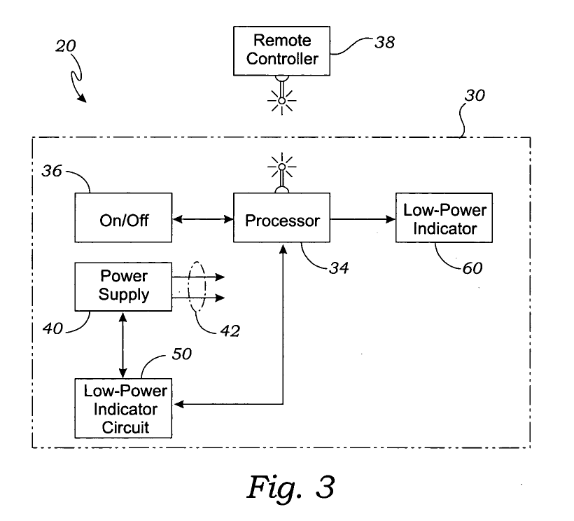

In use, an operator 120 operates the remote-controlled vehicle 30 of the vehicle and indicator apparatus 20 of the present invention through the remote controller 38, resulting in a decrease of the vehicle's power supply 40. This drop in power is monitored by the low-power indicator circuit 50. When a predetermined low-power condition of the power supply 40 is detected, the low-power indicator 60 is actuated to indicate low power of the power supply 40 to the operator 120 so that the vehicle 30 may be safely guided back before all power is lost and the vehicle 30 crashed or unrecovered. In the exemplary embodiment of FIGS. 1-4, a battery-type power supply 40 is operably connected to the vehicle 30 and to the low-power indicator circuit 50. The low-power indicator circuit 50 detects the operating voltage of the power supply 40 as the vehicle 30 is operated and compares the detected operating voltage to a desired voltage range as set in the low-power indicator circuit 50. When the operating voltage is outside of the voltage range or is more than a preset cut-off percentage below the nominal voltage so as to cause a low-power condition, the low-power indicator circuit 50 controls the actuation of the low-power indicator 60 to signal the operator 120. Again, the detection of the low-power condition and resulting actuation of the low-power indicator 60 may be controlled by the low-power indicator circuit 50 alone, through the processor 34 as shown schematically in FIG. 3, or through numerous other circuitry arrangements as are now known or later developed in the art to suit various remote-controlled vehicle 30 and power supply 40 arrangements. In the first exemplary embodiment, when the low-power condition of the power supply 40 is detected, the low-power indicator circuit 50 controls the solenoid device 78 to retract the slidable catch 80 in the direction of the arrow 82 to release the clip 74. As a result, the second half 70 of the chamber 64 is freed to pivot about the hinge 72 in the direction of the arrow 84, which pivoting is enabled by gravity, though it may be further enabled by a mechanical actuation device (not shown) such as a solenoid or servo motor. The pivoting of the second half 70 thus opens the chamber 64, allowing the streamers 66 housed within the chamber 64 to extend from, or stream behind, the vehicle 30, visibly alerting the operator 120 a distance away from the vehicle 30 of its low-power condition. Once the vehicle 30 has been safely landed in response to actuation of the low-power indicator 60 and the power supply 40 has been recharged or replaced or the vehicle 30 simply turned off, the low-power indicator circuit 50 resets, allowing the solenoid 78 to shift the catch 80 back to its extended position as shown in FIG. 2. The low-power indicator 60 is then reset by folding the streamers 66 again within the chamber 64 and pivoting the second half 70 of the chamber 64 about the hinge 72 to snap the clip 74 over the catch 80 and close the chamber 64. While the streamer device 62 is shown mounted on the underside of the vehicle 30, it will be appreciated by those skilled in the art that any such visible indicator 60 may be mounted anywhere on the vehicle 30 that is convenient for alerting the operator of the low-power condition while not interfering with the operation of the vehicle 30. It will be further appreciated that a virtually unlimited number of configurations of the chamber 64, the streamers 66, and the mechanical coupling of the chamber 64 to the control circuitry of the vehicle 30 is possible without departing from the spirit and scope of the present invention.

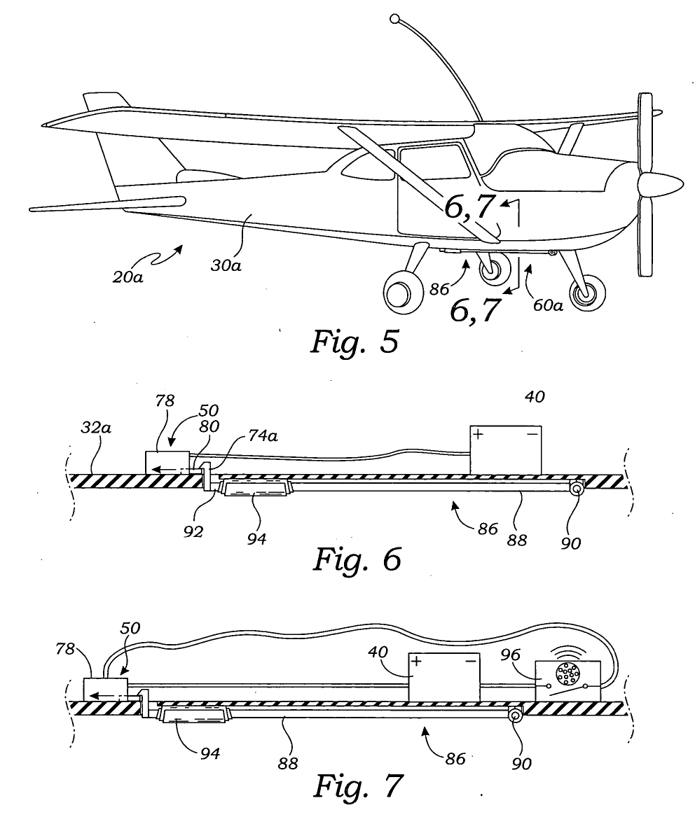

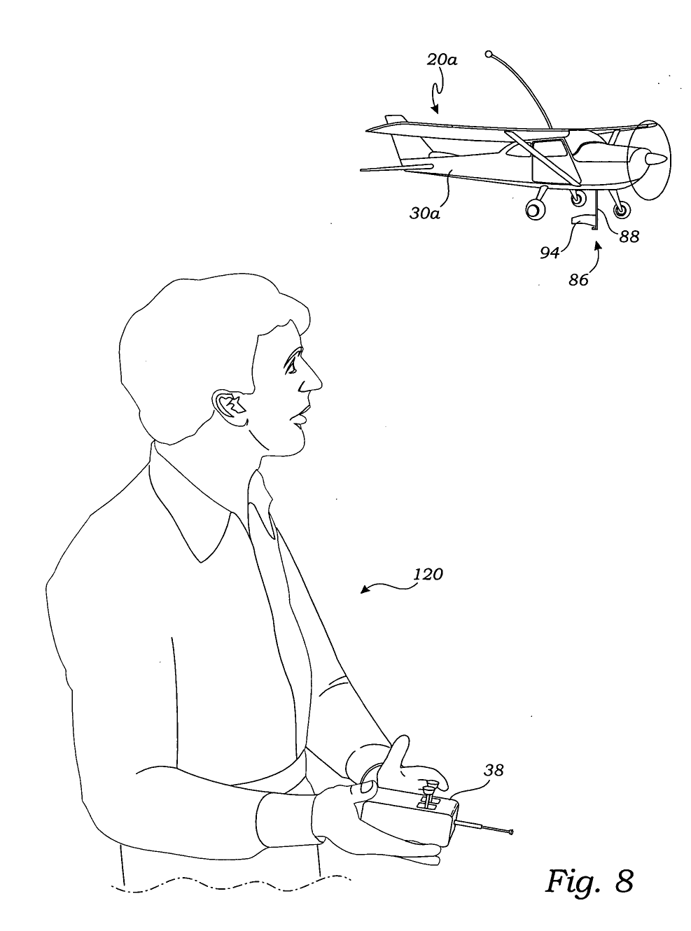

Turning now to FIGS. 5-8, there is shown a second exemplary embodiment of the vehicle and indicator apparatus 20a of the present invention. A remote-controlled vehicle 30′ is again provided as a model aircraft, but the visible, mechanical low-power indicator 60′ now comprises a flag device 86. The flag device 86 comprises a staff 88 mounted on the bottom wall 32a of the vehicle 30 so as to have a pivotable fixed end 90 and an opposite free end 92 and a flag 94 attached to the staff substantially at the free end 92 such that pivoting the staff 88 about the fixed end 90 under control of the low-power indicator circuit 50 extends the free end 90 away from the remote-controlled vehicle 30 so as to fly the flag 94 and visibly indicate low power to the operator 120. In the second exemplary embodiment, as shown in section in FIG. 6, it will be appreciated that the cooperation of the low-power indicator circuit 50 with the solenoid 78 in response to a detected low-power condition of the power supply 40 again results in the shifting of the catch 80 to release a clip 74a formed on the low-power indicator 60, here the flag device 86, and thereby allowing the low-power indicator 60 to be deployed to visibly signal the low power condition to the operator 120. Again, once the clip 74a is released, gravity alone causes the staff 88 of the flag device 86 to pivot about its fixed end 90, unfurling the flag 94 as shown in FIG. 8. It will be appreciated that the flag device 86 may be mounted on numerous other locations on the vehicle 30 so as to be deployed under the power of gravity alone or in combination with a mechanical actuation device (not shown) so as to be selectively visible at a selected distance from the remote-controlled vehicle 30. Referring to FIG. 7, there is shown a related alternative exemplary embodiment of the low-power indicator 60 of the present invention comprising both a visible indicator and an audible indicator. The visible indicator is again configured as the exemplary flag device 86, though it will be appreciated by those skilled in the art that the exemplary streamer device 62 described above, the exemplary smoke device 98 described below, or any number of other visible, mechanical low-power indicators may be employed in the present invention, and in the specific exemplary embodiment in which such a visible indicator is utilized in conjunction with an audible indicator, without departing from its spirit and scope. It will be further appreciated that while the audible indicator is shown and described as being used in conjunction with a visible indicator, it is also contemplated that the audible indicator may be employed as the sole low-power indicator 60, without any other such indicator, visible or otherwise. In the alternative exemplary embodiment shown in FIG. 6, low-power indicator 60 is thus configured such that the visible indicator is, again, the flag device 86 as described above and the audible indicator is a speaker device 96. The audible low-power sounds sent from the speaker device 96 may be any number of constant or intermittent alarms, tones, chirps or other such sounds that would be selectively audible to the operator 120 or others at a selected distance from the remote-controlled vehicle 30. The low-power indicator circuit 50 is operably connected to the power supply 40 and both to the solenoid 78 for selective mechanical operation of the flag device 86 and to the speaker device 96. In this way, when the low-power indicator circuit 50 detects a low-power condition of the power supply 40, it is configured to selectively control the actuation of both the visible indicator, here, the flag device 86, and the audible indicator, here, the speaker device 96. In one exemplary mode of operation, the low-power indicator circuit 50 is configured to detect when the operating voltage of the power supply 40 is within a first outside range defined as outside the prescribed operating voltage range and no more than a preset, cut-off percentage below the nominal voltage and to enable actuation of the audible speaker device 96 when the operating voltage falls within the first outside range, and the low-power indicator circuit 50 is further configured to detect when the operating voltage is within a second outside range defined as more than the cut-off percentage below the nominal voltage and to enable actuation of the visible flag device 86 when the operating voltage falls within the second outside range. The cut-off percentage below the nominal voltage can vary in the exemplary embodiments from 5% to 50%, but is preferably approximately 10%. That is, in a preferred embodiment of the present invention, the low-power indicator circuit 50 is configured to first actuate an audible indicator such as the speaker device 96 when the operating voltage of the power supply 40 falls outside the operating voltage range but no more outside this voltage range than 10% of the nominal voltage of the power supply 40. Then, if operation of the vehicle 30 is continued and the power supply 40 is drawn down further to a point outside the operating voltage range greater than 10% from the power supply's nominal voltage, the low-power indicator circuit is then configured to actuate a visible indicator such as the flag device 86. In an alternative exemplary mode of operation of the vehicle and indicator apparatus 20a of the present invention, the low-power indicator circuit 50 is configured to detect when the operating voltage is within an outside range defined as more than a preset, cut-off percentage below the nominal voltage and to enable simultaneous actuation of the audible and visual indicators when the operating voltage falls within the outside range. For example, if the cut-off percentage was again selected to be approximately 10%, when the operating voltage of the power supply 40 is detected as being in the outside range, or more than 10% below the nominal voltage, the low-power indicator circuit 50 would actuate both the flag device 86 and the speaker device 96 to alert the operator 100 of this low-power condition. It will be appreciated by those skilled in the art that the indicators disclosed are merely exemplary of a variety of visible and audible indicators that may be employed alone or in combination in the low-power indicator 60 of the present invention. Moreover, a variety of operational set points and sequences of such indicators may also be employed without departing from the spirit and scope of the invention.

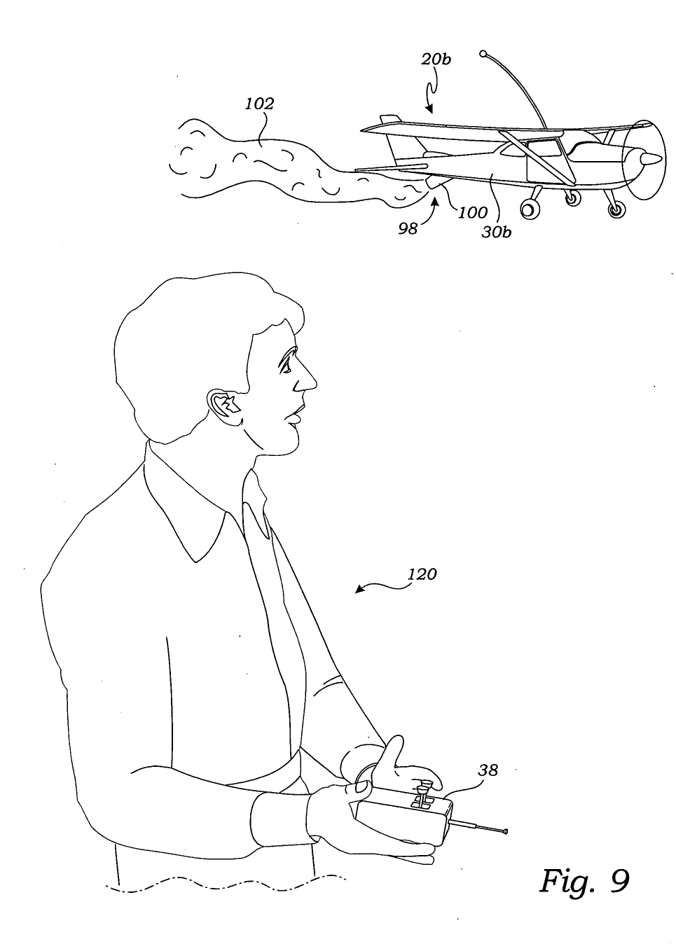

Referring now to FIG. 9, there is shown in use another exemplary embodiment of the vehicle and indicator apparatus 20b of the present invention in which the remote-controlled vehicle 30b is still configured as a model aircraft, but the visible, mechanical low-power indicator 60b now comprises a smoke device 98. The smoke device 98 comprises a smoke source 100 formed on the remote-controlled vehicle 30b and operably connected to the low-power indicator circuit 50 (FIG. 3) such that actuating the smoke source 100 under control of the low-power indicator circuit 50 releases smoke 102 from the smoke source 100 so as to emanate from the vehicle 30b and visibly indicate low power. As with the exemplary streamer device 62 and flag device 86 embodiments of the low-power indicator 60, the low-power indicator circuit 50 is operably connected to the power supply 40 so as to detect decreases in operating voltage, in the exemplary case of a battery-type power supply, and, based on a detected low-power condition, to actuate the smoke source 100 to again alert the operator 120 of the low-power condition. The smoke source 100 may be any device now known or later developed in the art for selectively generating a cloud or stream of smoke under the control of the low-power indicator circuit 50, alone or in combination with a processor 34. The smoke 102 may be colored or otherwise enhanced for visibility. As with the other visible, mechanical indicators, the smoke source 100 may be mounted anywhere on the vehicle 30b so as to effectively emanate smoke upon a low-power condition while not adversely affecting the operation of the vehicle 30b. The smoke source 100 may be rigidly mounted on the vehicle 30b or configured so as to be selectively moveable on or retracted within the vehicle 30b. Again, while the visible indicator has been shown and described in the various exemplary embodiments as either a streamer device 62, a flag device 86, or a smoke device 98, it will be appreciated by those skilled in the art that a number of other visible, mechanical low-power indicators, such as LEDs, strobes, signs, banners, color changes, or other such visually perceptible indicators may be employed in the present invention without departing from its spirit and scope.

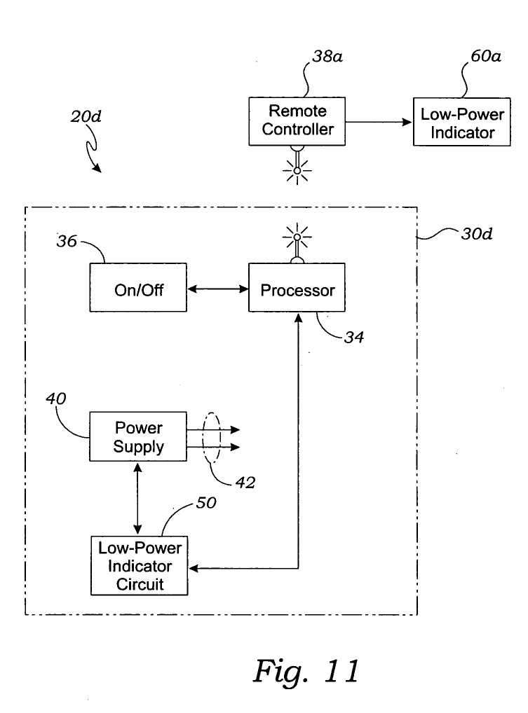

As shown schematically in FIG. 10, yet another exemplary embodiment of the vehicle and indicator apparatus 20c of the present invention includes a power supply 40a comprising an engine 44 and a tank 46 providing fuel (not shown) to the engine 44. The engine may be any miniature combustion engine operating on a liquid fuel source, or other such device now known or later developed, and employed in the art of remote-controlled vehicles and the like. The tank 46 is configured with a fuel gage 47 having a low-level setting. The low-power indicator circuit 50 is operably connected to the fuel gage 47 and is configured to enable actuation of the at least one low-power indicator 60 when the fuel in the tank 46 falls to the low-level setting. When such a low-level of fuel is detected, it will be appreciated that the low-power indicator circuit 50 will detect such low-power condition and actuate the low-power indicator 60 accordingly, as described more fully above. As with the other exemplary embodiments of the present invention, a variety of visible, audible and other indicators may be employed in alerting the operator 120 of the low-fuel condition of the remote-controlled vehicle 30c without departing from the spirit and scope of the present invention. Turning to the schematic of FIG. 11, there is shown an exemplary embodiment of the present invention in which the low-power indicator 60a is mounted on the controller 38a. Because the controller 38a is configured to enable remote control of the remote-controlled vehicle 30d and so is held by the operator 120 during use of the vehicle 30d, the low-power indicator 60a need not be visible or audible from a distance. Even so, the low-power indicator mounted on the controller 38a may be any of a number of visible or audible indicators described herein or known or later developed in the art for alerting an operator. The low-power indicator 60a will again be under the control of low-power indicator circuit 50, whether directly or as shown through a processor 34, only the operable connection between the low-power indicator circuit 50 and the low-power indicator 60a will now be achieved through remote-control, or radio-control, signals passing between the vehicle 30d and the controller 38a. In this way, the low-power indicator 60a, though mounted on the controller 38a, does not detect a low-power condition of the controller itself, but still of the remote-controlled vehicle 30d. Therefore, in all the exemplary embodiments, the vehicle and indicator apparatus of the present invention is configured to detect a low-power condition of a remotely-controlled vehicle and generate a visible or audible signal alerting the operator of the low-power condition so that the operator may guide the vehicle to a safe location or cease operation of the vehicle so as to protect the vehicle and others from danger.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A vehicle and indicator apparatus comprising:
a remote-controlled vehicle;
a power supply operably connected to the remote-controlled vehicle;
a low-power indicator circuit operably connected to the power supply; and
at least one low-power indicator operably connected to the low-power indicator circuit and configured to be enabled when a low-power condition is present.

2. The apparatus of claim 1 wherein the at least one low-power indicator comprises a visible indicator mounted on the remote-controlled vehicle.

3. The apparatus of claim 2 wherein the visible indicator comprises a streamer device.

4. The apparatus of claim 3 wherein the streamer device comprises:
a selectively-openable chamber formed on the remote-controlled vehicle and operably connected to the low-power indicator circuit; and
at least one streamer housed within the chamber and attached on one end to the chamber such that opening the chamber under control of the low-power indicator circuit releases the at least one streamer so as to stream behind the remote-controlled vehicle and visibly indicate low power.

5. The apparatus of claim 2 wherein the visible indicator comprises a flag device.

6. The apparatus of claim 5 wherein the flag device comprises:
a staff mounted to the remote-controlled vehicle so as to have a pivotable fixed end and an opposite free end, the staff being operably connected to the low-power indicator circuit; and
a flag attached to the staff substantially at the free end such that pivoting the staff about the fixed end under control of the low-power indicator circuit extends the free end away from the remote-controlled vehicle so as to fly the flag and visibly indicate low power.

7. The apparatus of claim 2 wherein the visible indicator comprises a smoke device, the smoke device comprising a smoke source formed on the remote-controlled vehicle and operably connected to the low-power indicator circuit such that actuating the smoke source under control of the low-power indicator circuit releases smoke from the smoke source so as to emanate from the remote-controlled vehicle and visibly indicate low power.

8. The apparatus of claim 1 wherein the at least one low-power indicator comprises an audible indicator mounted on the remote-controlled vehicle.

9. The apparatus of claim 1 wherein the at least one low-power indicator comprises:
an audible indicator mounted on the remote-controlled vehicle so as to be selectively audible at a selected distance from the remote-controlled vehicle; and
a visible indicator mounted on the remote-controlled vehicle so as to be selectively visible at a selected distance from the remote-controlled vehicle.

10. The apparatus of claim 1 wherein:
the power supply provides an operating voltage within a predetermined voltage range having a nominal voltage; and
the low-power indicator circuit is configured to detect the operating voltage and to enable actuation of the at least one low-power indicator when the operating voltage falls outside the voltage range.

11. The apparatus of claim 10 wherein the at least one low-power indicator comprises a visible indicator mounted on the remote-controlled vehicle.

12. The apparatus of claim 10 wherein the at least one low-power indicator comprises an audible indicator and a visible indicator mounted on the remote-controlled vehicle.

13. The apparatus of claim 12 wherein:
the low-power indicator circuit is configured to detect when the operating voltage is within a first outside range defined as outside the voltage range and no more than a cut-off percentage below the nominal voltage and to enable actuation of the audible indicator when the operating voltage falls within the first outside range; and
the low-power indicator circuit is further configured to detect when the operating voltage is within a second outside range defined as more than the cut-off percentage below the nominal voltage and to enable actuation of the visible indicator when the operating voltage falls within the second outside range.

14. The apparatus of claim 12 wherein the low-power indicator circuit is configured to detect when the operating voltage is within an outside range defined as more than a cut-off percentage below the nominal voltage and to enable simultaneous actuation of the audible and visual indicators when the operating voltage falls within the outside range.

15. The apparatus of claim 1 wherein:
the power supply comprises an engine and a tank providing fuel to the engine, the tank including a fuel gage configured with a low level setting; and
the low-power indicator circuit is operably connected to the fuel gage and is configured to enable actuation of the at least one low-power indicator when the fuel in the tank falls to the low level setting.

16. The apparatus of claim 1 further comprising a controller configured to enable remote control of the remote-controlled vehicle, wherein the at least one low-power indicator comprises a visible indicator mounted on the controller.

17. The apparatus of claim 1 wherein the remote-controlled vehicle is selected from the group consisting of a land vehicle, a boat, and an aircraft.

18. A vehicle and indicator apparatus comprising:
a remote-controlled vehicle;
a power supply operably connected to the remote-controlled vehicle;
a low-power indicator circuit operably connected to the power supply; and
a means for indicating low power of the power supply operably connected to the low-power indicator circuit.

19. A vehicle and indicator apparatus comprising:
a remote-controlled vehicle;
a power supply operably connected to the remote-controlled vehicle;
a low-power indicator circuit operably connected to the power supply; and
a mechanical low-power indicator mounted on the remote-controlled vehicle and operably connected to the low-power indicator circuit.

20. The apparatus of claim 19 wherein the mechanical low-power indicator is selected from the group consisting of a streamer device, a flag device, and a smoke device.

21. A vehicle and indicator apparatus comprising:
a remote-controlled vehicle;
an electrical battery operably connected to the remote-controlled vehicle;
a low-battery life indicator circuit operably connected to the battery; and
at least one low-battery life indicator operably connected to the low-battery life indicator circuit so as to be deployed when the electrical battery has a low battery life, the low-battery life indicator engaged with the vehicle and visible from an exterior position relative thereto.

22. A method of indicating low power of a remote-controlled vehicle, comprising the steps of:
operating the remote-controlled vehicle so as to decrease a power supply connected to the remote-controlled vehicle;
detecting a low power condition of the power supply as the remote-controlled vehicle is operated; and
actuating at least one low-power indicator when the low power condition is detected to indicate low power of the power supply.

23. The method of claim 22 comprising the further steps of:
detecting an operating voltage of the power supply as the remote-controlled vehicle is operated;
comparing the operating voltage to a desired voltage range as set in a low-power indicator circuit operably connected to the power supply; and
controlling the actuation of the at least on low-power indicator through the low-power indicator circuit.

24. The method of claim 23 comprising the further steps of:
setting a first outside range in the low-power indicator circuit;
actuating an audible indicator of the at least one low-power indicator when the operating voltage falls within the first outside range;
setting a second outside range in the low-power indicator circuit; and
actuating a visible indicator of the at least one low-power indicator when the operating voltage falls within the second outside range.

25. The method of claim 22 comprising the further steps of:
detecting a fuel level in a tank providing fuel to an engine as the remote-controlled vehicle is operated;
comparing the fuel level to a low level setting of a fuel gage operably connected to a low-power indicator circuit; and
controlling the actuation of the at least one low-power indicator through the low-power indicator circuit.

26. The method of claim 22 comprising the further steps of:
operably connecting a low-power indicator circuit to the power supply;
mounting the at least one low-power indicator on the remote-controlled vehicle so as to be mechanically operated by the low-power indicator circuit;
operating the at least one low-power indicator under control of the low-power indicator circuit to visibly extend the at least one low-power indicator from the remote-controlled vehicle.
